(19) United States
(12) Patent Application Publication
(10) Pub. No.: US 2007/0124078 A1
(43) Pub. Date: May 31, 2007

(54) Vehicle impact avoidance system

(76) Inventor: Garry Vinje, Prince George (CA)

Correspondence Address: ANTONY C. EDWARDS, SUITE 200 - 270 HIGHWAY 33 WEST, KELOWNA, BC, V1X 1X7, CA

(21) Appl. No.: 11/286,430

(22) Filed: Nov. 25, 2005

(51) Int. Cl. G08G 1/16

(52) U.S. Cl. 701/301; 701/213

(57) ABSTRACT

A system whereby vehicles travelling on unmapped roadways, such as logging or industrial roadways, may initially record a linear distance electronic image of the roadway being travelled, based upon position data received and stored from a remote satellite global positioning system, and, using the position data, to continuously broadcast a radio frequency signal identifying that position on that roadway and receive from at least one other suitably equipped vehicle a continuously broadcast radio frequency signal of the other vehicles' coordinates so that a suitable visual or auditory signal may be activated to warn the operator of the vehicles when the vehicles close within a predetermined range.

### FIELD OF THE INVENTION

This invention relates to a system whereby vehicles travelling on unmapped roadways, such as logging or industrial roadways, can initially record a linear distance electronic image of the roadway being travelled, based upon position data received and stored from a remote satellite global positioning system, and, using the position data, to continuously broadcast a radio frequency signal identifying that position on that roadway and receive from at least one other suitably equipped vehicle a continuously broadcast radio frequency signal of the other vehicles similar coordinates so that a suitable visual or auditory signal may be activated to warn the operator of the vehicles when the vehicles close within a predetermined range.

### BACKGROUND OF THE INVENTION

In the area of logging, oil exploration and other areas where heavy equipment is operated, a risk of vehicle damage and operator injury exist due to vehicular traffic, that is, opposite two-way movement of oversized and heavily burdened vehicles over difficult road conditions.

Operators of such vehicles may normally utilize two-way radios or the like on a predetermined frequency to notify others of their location on the roadway. For example, on a logging road, the truck operators call out on the radio mileage markers as they pass the markers. This method may be ineffectual, as traffic volume may become heavy and operating such vehicles requires concentration, and, further, the operator may miss or forget to call out the mileage marker, may turn off the radio to reduce distraction from unnecessary chatter, be in a location where radio signals are attempted or impeded, or have the radio on the wrong frequency.

It is evident therefore, that a need exist for a vehicle impact and avoidance system that can automatically assess and simply display a threat level posed by nearby vehicles, where the displayed thread level is in direct relationship to the distance separating those vehicles, their direction of movement and their speed.

In the prior art the applicant is aware of U.S. Pat. No. 6,658,355 which issued Dec. 2, 2003 to Miller et al for a Method and Apparatus for Activating a Crash Countermeasure which describes a system for sensing a potential collision of a first vehicle with a second vehicle. The first vehicle has a pre-crash sensing system, which includes a controller coupled to a GPS system, a sensor data block, a receiver and transmitter and a warning display. The controller has a proximity detector used to determine the proximity of the various vehicles around the first vehicle. A vehicle trajectory block is used to determine the trajectory of the first vehicle and the surrounding vehicles such that a threat assessment can be made. If a threat is detected, based on various vehicle data and sensor data from the sensor block, the system activates a counter-measure system in response to the threat level.

### SUMMARY OF THE INVENTION

What is neither taught nor suggested individually nor collectively by the prior art and which it is an object of the present invention to provide includes:
a) a system whereby as a vehicle travels off-highway, GPS derived position coordinates for that vehicle are utilized to create a linear distance map of working roadway being traveled where no map has already been made or presently exists and re-broadcasts the position coordinates locally by radio, etc to other vehicles in the area;
b) a system whereby maps for roadways within a retrieval database which have no known hazard may be suitably identified so that the operator warning system is deactivated;
c) a system whereby only vehicles that pose a direct threat are tracked and displayed as a threat level when off-highway, and other non-threatening traffic situations are filtered out;
d) a system where location coordinates transmitted by a vehicle may be rebroadcast through a repeater station to extend the range of communication and to avoid transmission interference by topography.

In summary, the present invention may be characterized in one aspect as an impact avoidance system primarily for use by vehicles such as industrial oversized vehicles travelling at speed along industrial, mining or logging roads or the like where the GPS position coordinates for each vehicle are shared amongst the vehicles by re-broadcast and updated.

Within each vehicle, that vehicle's GPS position coordinates are compared with roadway maps within a database to determine a precise location of a vehicle as it travels on the roadway. Should no such roadway map match the GPS coordinates the vehicle impact and avoidance system commences self-mapping of the roadway to record an electronic image or trace of the real linear distance of the roadway as it is being traveled by the vehicle.

The mapping database may also contain roadways that are not a hazard for travel and these maps are suitably identified by the microprocessor associated with the system so that the operator warning system is temporarily deactivated.

Current GPS coordinates are continuously transmitted from that vehicle so as to be received by other similarly equipped vehicles traveling on that roadway. Where necessary, such transmission may be rebroadcast through a repeater station to extend the range of communication and to avoid transmission interference by topography or climate.

A microprocessor filters incoming GPS data from other vehicles to determine whether a proximity or directional hazard exists from those vehicles within a predetermined distance. Such filtering eliminates non-hazard situations and only activates a suitable operator warning when a possible hazard situation is determined.

Hazard determination is based upon multiple zones of detection being electronically created, similar to shells or polygons, radiating outwardly from and surrounding a vehicle. Such zones identify a potential impact hazard based on distance and direction of travel.

Where a vehicle impact has occurred this vehicle impact and avoidance system will store such information as would be of assistance to aid accident analysis and evaluation.

### BRIEF DESCRIPTION OF THE DRAWINGS

FIG. 1, is a schematic view of several vehicles receiving GPS coordinate information from a remote satellite global positioning system and continuously broadcasting a radio frequency signal identifying their location to other vehicles.

FIG. 2 is a schematic view of a vehicle surrounded by multiple electronically created zones of detection.

FIG. 3 is a schematic illustration of multiple vehicles utilizing a hillside roadway containing several hairpin corners.

FIG. 4 is an enlarged schematic illustration of a portion of the roadway shown in FIG. 3 with multiple vehicles converging at a hairpin corner.

FIG. 5 is a view similar to that illustrated in FIG. 4 with the vehicles converging.

FIG. 6 is a view similar to that illustrated in FIG. 5 with the vehicles converging still closer.

FIG. 7 is a schematic logic flow chart of one embodiment of the system according to the present invention.

FIG. 8 is an illustration of the interior of a truck cab showing a display having hazard warning lights mounted thereon according to one embodiment of the present invention.

### DETAILED DESCRIPTION OF EMBODIMENTS OF THE INVENTION

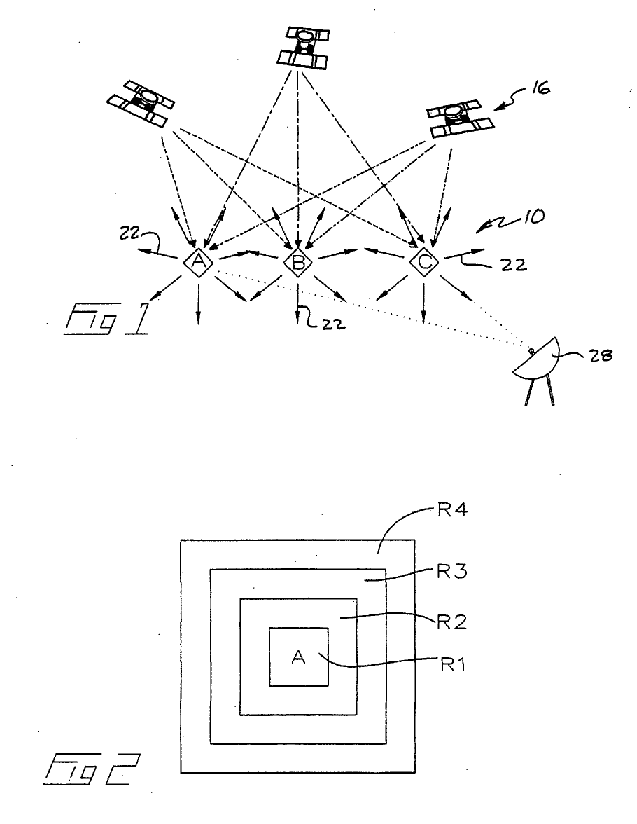

The vehicle impact and avoidance system 10 of the present invention will, when a vehicle, for example either A, B or C, initially travels a roadway such as logging road 12, compare currently obtained GPS data with a database of maps 14, and retrieve for use a map of the roadway. Where no map exists in database 14, the vehicle impact and avoidance system will record an electronic image of the real linear distance of the roadway being travelled by retrieving and storing coordinates obtained from a multi-satellite global positioning system 16 as illustrated in FIG. 1.

As the vehicles A, B or C, travel roadway 12 such GPS data is continuously updated, thereby identifying the precise coordinates of the subject vehicle as it travels along that roadway. A transceiver 20 continuously broadcasts this data by way of radio frequency signals 22 identifying the position of the subject vehicle to at least one other vehicle travelling on the same roadway.

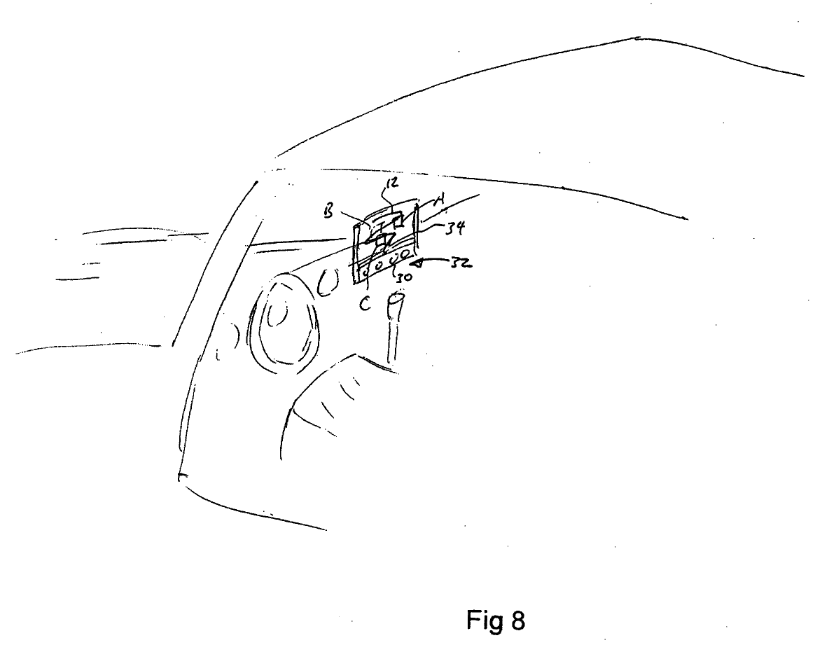

Receiving units in all vehicles filter incoming data through a microprocessor 24 to determine either a proximity or directional hazard, Should a possible hazard be determined, suitable operator warning will be activated, for example by illuminating one or more lights or light emitting diodes 30 or activating other warning signals whether or not in an array 32 mounted to a display 34 on which may be displayed a representation of the position of vehicles on a roadway 12 as seen in FIG. 8.

As may be viewed schematically in FIG. 2, hazard determination may be based upon multiple concentric zones of detection R1, R2, R3 and R4 being electronically created, similar to shells or polygons and radiating outwardly from and surrounding vehicle A, for example. Each zone or shell may be a multiple of the distance of the first radial distance, for example if R1 extends 100 m around the vehicle i.e. a polygon having sides 200 m in length, then zone R2 may be a polygon having sides of 400 m in length. R4 may be dictated by the maximum range giving a high probability (for example 98%) of successful RF data transmission. For example R4 may be in the order of several kilometres where conditions permit.

FIG. 3 schematically illustrates several vehicles A, B, and C on roadway 12 spaced apart sufficiently so that no threat is imminent. Vehicle C is travelling in a direction opposite to that of A and B. The assumption is that there is no visual contact between operators as is often the case on mountain logging roads.

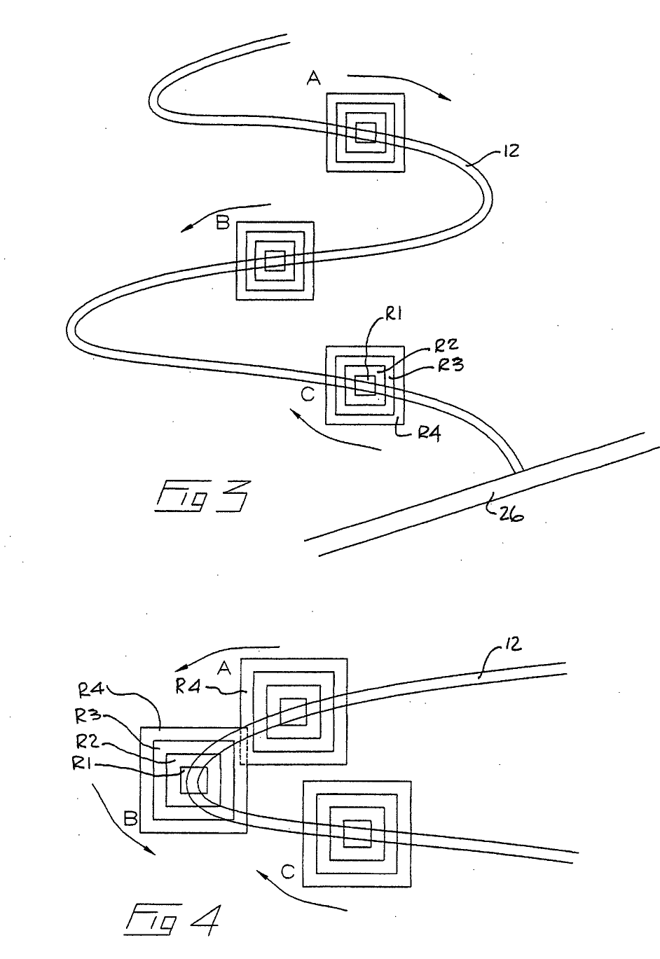

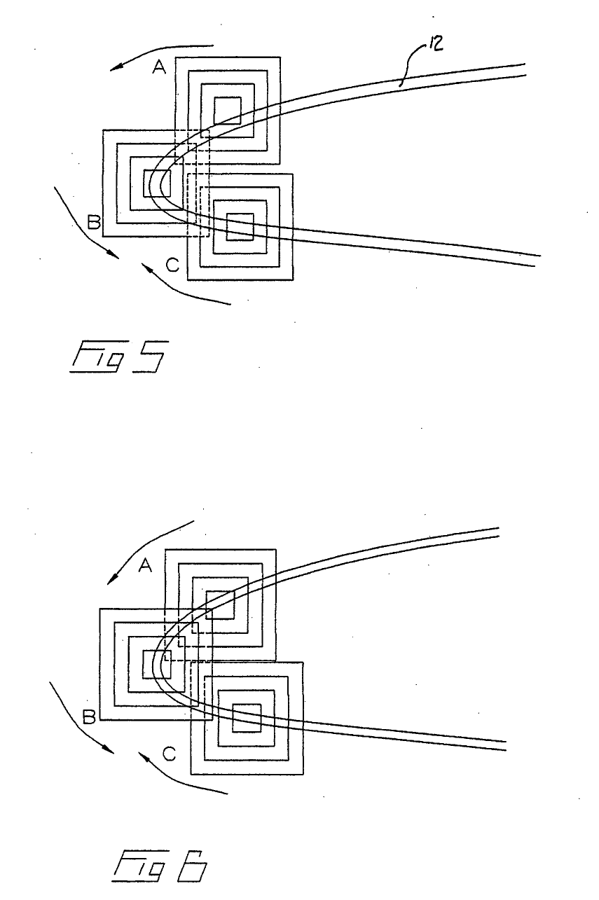

As vehicle A starts to overtake vehicle B, as in FIG. 4, the outermost detection zones, R4 of the respective vehicles are impinged and microprocessor 24 will automatically determine the level of threat that exists and activate a suitable operator warning, such as by lighting one of an array of lights, light emitting diodes, by triggering the first of a sequence of sounds, or other such escalating warning signs.

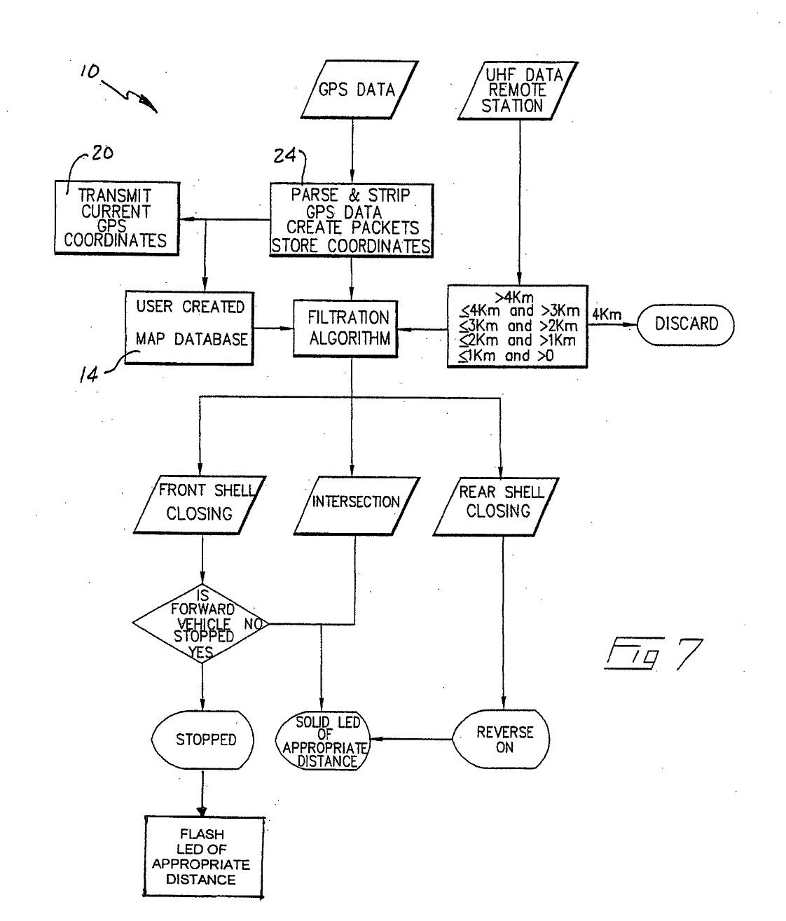

A filter incorporating a filtration algorithm such as shown in the diagram of FIG. 7 bases threat assessments upon roadway distance by using a self-mapped map rather than on straight-line distances between vehicles. For example, as two vehicles approach a curve or switchback the straight-line distance between the two vehicles will be shorter than the linear road distance. A built-in fail-safe scenario in the filter chooses the straight-line distance if for example the map data is uncertain. The threat assessment may also be directionally sensitive, e.g. as vehicles pass one-another, successively fewer electronic detection zones are impinged indicating that the vehicles are travelling in opposite directions, thus no operator warning would be necessary.

Should vehicle B, for example, be stationary and the same road then for example the appropriate warning light would flash in vehicle A as one way to warn vehicle A that vehicle B is stopped, and vehicle B would have a solid or continuous warning light to warn of approaching vehicle A. FIG. 7 includes this special case. This is for situations where there is a dusty environment and in limited visibility situations. Many rear end collisions have occurred when a vehicle is stopped (or very slow moving) in limited visibility. If vehicle B is moving away from vehicle A, a low level of warning may be activated or if the threat assessment is determined as nil then no warning is given. If the distance between the two vehicles is closing then warnings of increasing urgency will be given as successively closer electronic zones, R3 and R2 are impinged.

Warnings are also directionally sensitive, as shown in FIG. 5. The proximity of the three vehicles will activate a suitable operator warning in all vehicles.

Roadways that are not a hazard for travel, such as a public highway 26, will be included within a mapping database but will be suitably identified by the microprocessor so that the operator warning system and transmitter is deactivated.

Coordinate data continuously transmitted by multiple vehicles may be rebroadcast by a remote repeater station 28 making sure that such transmissions are not subject to interference due to topography.

In the case of a vehicle impact the vehicle impact and avoidance system is designed to store such information as would be of assistance to aid analysis of the situation.

FIG. 8 is an illustration of the interior of a truck cab showing a display having hazard warning lights mounted thereon according to one embodiment of the present invention. The processor may reside inside the radio unit, connected to the display 34. The display 34 may have four LED's (Forward 5 Km, Forward 3 Km, Forward 1 Km and Reverse 1 Km for example). A cable attachment allows the display to be located according to the preference of the operator, and can be mounted on the visor, dash or wherever the operator desire. The display itself may be small (in the range of 3 cm wide by 1 cm tall and 3 cm long).

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A vehicle impact avoidance system comprising a means for determining that a first vehicle is travelling off-highway, means for processing GPS-derived position coordinates for said first vehicle so as to create a linear distance map of a working roadway being travelled by said first vehicle and storing said map if no corresponding map has already been made and stored, and means for re-broadcasting said position coordinates for said first vehicle locally by radio frequency transmission to other vehicles in the adjacent area, means for receiving radio-frequency transmissions from said other vehicles of the GPS-derived position co-ordinates for said other vehicles, means for comparing said position co-ordinates for said other vehicles with said position coordinates for said first vehicle, means for indicating to a driver of said first vehicle a threat level corresponding to a likelihood of impending collision based on said comparison.

2. The system of claim 1 further comprising means for identifying, within said stored roadways, roadways which are not hazardous and deactivating any indication of said threat level due to said impending collision.

3. The system of claim 1 further comprising means for determining which of said other vehicles are vehicles that pose a direct impact threat to said first vehicle of those said other vehicles which are tracked and displayed as a threat level when off-highway, and filtering out other non-threatening traffic patterns involving said first vehicle and said other vehicles, wherein said non-threatening traffic patterns include wherein said first vehicle and said other vehicles are within a pre-set warning proximity but are moving along paths which will not intersect.

4. The system of claim 1 further comprising means for creating electronic zones of detection, each zone of said zones of detection corresponding to one vehicle of said first vehicle or said other vehicles, each said zone radiating outwardly from and surrounding a corresponding said vehicle, and means for identifying said zones and determining a potential impact hazard based on a comparison of distance between and direction of travel of said zones.

5. The system of claim 3 wherein said pre-set warning proximity is substantially equal to a distance at which said radio frequency transmissions are received between said first vehicle and said other vehicles with a pre-set statistical certainty of accurate transfer of said position co-ordinates.

6. The system of claim 5 wherein said pre-set statistical certainty is ninety-five percent.

7. The system of claim 1 wherein when said map has already been made and stored and wherein when said means for comparing determines said position coordinates for said first vehicle and said other vehicles lie on said map which has already been made and stored, then said comparison by said means for comparing is a comparison of at least distances between said first vehicle and said other vehicles along a path coinciding with that portion of said map which has been made and stored between said first vehicle and said other vehicles, otherwise said means for comparing compares a linear distance directly and linearly between said first vehicle and said other vehicles.

8. A method for avoiding impact between approaching vehicles comprising the steps of:
a) providing a first transceiver/processor unit
b) receiving in said first unit position coordinates for present position from a remote/satellite based positioning system,
c) broadcasting from said first unit a radio frequency signal containing the position coordinates for said present position (continuously/intermittently),
d) receiving in said first unit RF signals containing position coordinates broadcast from at least a second transceiver/processor unit when within radio frequency range of said first unit,
e) computing in said first unit a linear distance in a straight line from said first unit to said second unit,
f) comparing in said first unit said present position of said first unit with stored maps stored in said first unit to locate a stored map having a vehicular first roadway coinciding, along said roadway, with said present position of said first unit,
g) comparing in said first unit said present position of said second unit with said stored maps to locate a second roadway coinciding, along said second roadway, with said present position of said second unit,
h) comparing said first and second roadways to determine if they respectively form part of a common roadway containing both said first and second roadways and identifying said common roadway, and if so identified then determining a path distance along said common roadway from said first unit to said second unit and comparing said path distance to a set of distance range values, ignoring said second unit if said path distance is above an outer distance threshold, triggering a proximity warning indicator to indicate to a user from a set of proximity warning indicators corresponding to said set of distance range values of said first unit a proximity warning corresponding to said path distance and a corresponding distance range value from said set of distance range values,
i) in the event said common roadway is not identified then comparing said linear distance to said set of distance range values and substituting said linear distance for said path distance and repeating step (h),
j) repeatedly repeating steps (b)-(h) according to a refresh frequency.
